(19) United States
(12) Patent Application Publication
(10) Pub. No.: US 2009/0237967 A1
(43) Pub. Date: Sep. 24, 2009

(54) Power factor correction circuit with buck and boost conversions

(75) Inventor: Ming-Ho Huang, Sanchung City (TW)

Correspondence Address: COOPER & DUNHAM, LLP, 30 Rockefeller Plaza, 20th Floor, NEW YORK, NY, 10112, US

(73) Assignee: HIPRO ELECTRONICS CO., LTD.

(21) Appl. No.: 12/077,550

(22) Filed: Mar. 20, 2008

(51) Int. Cl. H02M 7/155

(52) U.S. Cl. 363/79

(57) ABSTRACT

A power factor correction circuit with buck and boost conversions has a rectifying circuit, a buck circuit and a boost circuit. When an input AC voltage of the power factor correction circuit is a relative low voltage, the AC voltage is converted to low level voltage by the buck circuit and then converted to an intermediate voltage with a desired level by the boost circuit. When the input AC voltage is a relative high voltage, the boost circuit is turned off. The input AC voltage is rectified and bucked to the intermediate voltage with a desired level.

### BACKGROUND OF THE INVENTION

1. Field of the Invention

The present invention relates to a power factor correction circuit, and more particularly to a power correction circuit combined with a boost circuit and a buck circuit selectively operated to increase power conversion efficiency.

2. Description of Related Art

With reference to FIG. 2, a conventional distributed voltage regulation (DPS) system includes a power factor correction circuit (70) as a front stage and a DC to DC converter (80) as a back stage. The power factor correction circuit (70) is a boost type circuit converting an AC voltage, for example 85-265V, to a DC voltage, for example 380-400V. The DC to DC converter (80) then transfers the DC voltage from the power factor correction circuit (70) to a constant DC voltage with a desired level such as 48V to be distributed.

With the advantages of high efficiency, high reliability and a relative wide input voltage, the DPS system has been used in the computer and communication products. However, the power factor correction circuit (70) in the system still needs to improve its efficiency.

Since the power factory correction circuit (70) is the boost type, the input voltage of any voltage level (85-265V) is converted to a relative high output voltage of 380-400V with power factor correction process. However, such a voltage boost conversion will cause a high switching loss decreasing the power conversion efficiency.

### SUMMARY OF THE INVENTION

The main objective of the present invention is to provide a power factor correction circuit with buck and boost conversions for adaptively bucking or boosting an input AC voltage according to the level of the input AC voltage to reduce the power conversion loss.

To accomplish the objective, the power factor correction circuit in accordance with the present invention has a rectifying circuit, a buck circuit and a boost circuit. When an input AC voltage of the power factor correction circuit is a relative low voltage such as 110V, the AC voltage is converted to low level voltage such as 90V by the buck circuit and then converted to an intermediate voltage with a desired level by the boost circuit. When the input AC voltage is a relative high voltage such as 220V, the boost circuit is turned off. The input AC voltage is rectified and bucked to the intermediate voltage with a desired level. Because the power factor correction circuit selectively uses buck or boost circuits to generate a final constant DC voltage depending on the input AC voltage levels, the switching loss can be reduced to increase the power conversion efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a power factor correction circuit in accordance with the present invention; and

FIG. 2 is a block diagram of a conventional distributed voltage regulation (DPS) system.

### DETAILED DESCRIPTION OF THE PREFERRED EMBODIMENT

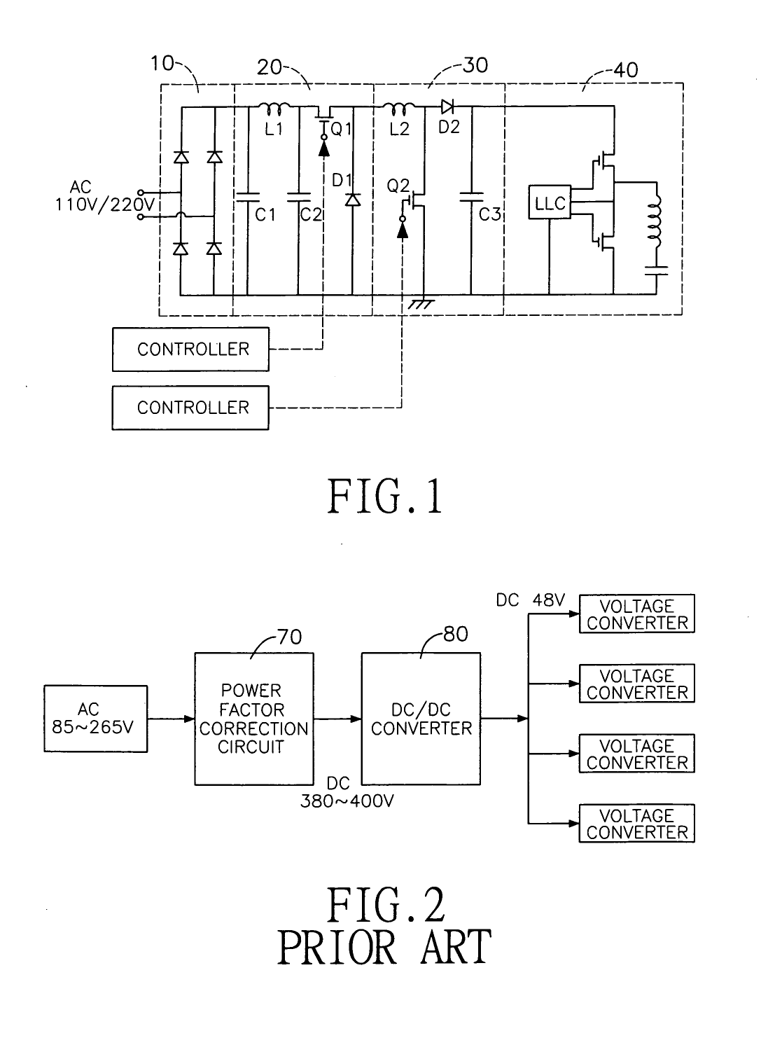

With reference to FIG. 1, a power factor correction circuit in accordance with the present invention comprises a rectifying circuit (10) a buck circuit (20) and a boost circuit (30).

The rectifying circuit (10) is implemented by a full wave rectifier such as a bridge rectifier with an input terminal and an output terminal. The input terminal of the rectifying circuit (10) receives an AC voltage. The rectifying circuit (10) converts the AC voltage to a DC voltage.

The buck circuit (20) comprises a coil (L1), a first power transistor (Q1), two capacitors (C1, C2) and a diode (D1). In this embodiment, the first power transistor (Q1) is a FET transistor with a gate connected to a controller. The controller determines whether the FET transistor should be turned on or turned off.

The boost circuit (30) comprises a coil (L2), a second power transistor (Q2), a capacitor (C3) and a diode (D2). The coil (L2) has one end as an input terminal connecting to an output terminal of the buck circuit (20). The coil (L2) has the other end connecting to the anode of the diode (D2) and the second power transistor (Q2). The cathode of the diode (D2) is used as an output terminal of the boost circuit (30). In this embodiment, the second power transistor (Q2) is a FET transistor with a gate connected to a controller. The controller determines whether the FET transistor should be turned on or turned off.

The controllers for the buck circuit (20) and the boost circuit (30) can be pulse width modulation (PWM) controllers capable of correcting power factor and converting the input voltage to an output voltage with a desired relative low or high level.

As described above, the power factor correction circuit in a power system is usually as a front stage. The DC voltage processed by the power factor correction circuit is then transferred to the back stage for DC to DC conversion. In this embodiment, the output terminal of the boost circuit (30) is connected a DC to DC conversion circuit (40). The DC to DC conversion circuit (40) can be implemented by a LLC resonant converter.

When the input AC voltage of the power correction circuit is 110V, both the power transistors (Q1, Q2) of the buck circuit (20) and the boost circuit (30) are turned on. The DC voltage, generated by the rectifying circuit (10), is firstly converted to a relative low level of 90V by the buck circuit (20), and subsequently converted to an intermediate DC voltage such as 190V by the boost circuit (30). The DC to DC conversion circuit (40) eventually transfers the intermediate DC voltage to a desired constant DC voltage such as 48V.

When the input AC voltage of the power correction circuit is 220V, the power transistor (Q2) of the boost circuit (30) is turned off and only the power transistor (Q1) of the buck circuit (20) is turned on. After the rectifying circuit (10) transfers the 220V AC voltage to a DC voltage, the buck circuit (20) converts the DC voltage to an intermediate DC voltage such as 190V. The DC to DC conversion circuit (40) eventually transfers the intermediate DC voltage to a desired constant DC voltage such as 48V.

In conclusion, when the input AC voltage is a relative low voltage, the present invention performs both buck and boost operations. When the input AC voltage is a relative high voltage, the present invention performs only the buck operation. For either the low or high input AC voltages, the power factor correction circuit transfers the input AC voltages to an intermediate DC voltages with the constant level to be further processed by a DC to DC conversion circuit. Since the present invention selectively uses buck or boost circuits to generate a final constant DC voltage depending on the input AC voltage levels, the switching loss can be reduced to increase the power conversion efficiency.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power factor correction circuit with buck and boost conversions comprising:
a rectifying circuit having an input terminal and an terminal and rectifying an AC voltage received from the input terminal to a DC voltage;
a buck circuit for power factor correction having an input terminal connected to the output terminal of the rectifying circuit, comprising a first power transistor that controls whether the buck circuit should be operated, and bucking the DC voltage received from the rectifying circuit; and
a boost circuit connected to an output terminal of the buck circuit, comprising a second power transistor that is selectively turned on or turned off based on whether the AC voltage is either a relative high voltage or a relative low voltage, and boosting the DC voltage output from the buck circuit.

2. The power factor correction circuit as claimed in claim 1, wherein the first and second power transistors respectively connect to two controllers.

3. The power factor correction circuit as claimed in claim 2, wherein the buck circuit further comprises a coil, two capacitors and a diode; the boost circuit further comprises a coil, a capacitor and a diode; and the first and second power transistors are FET transistors.

4. The power factor correction circuit as claimed in claim 3, wherein FET transistors have gates respectively connected to the controllers.

5. The power factor correction circuit as claimed in claim 4, wherein the controllers are PWM controllers.

6. The power factor correction circuit as claimed in claim 1, wherein an output terminal of the boost circuit further connects to a DC to DC conversion circuit.

7. The power factor correction circuit as claimed in claim 2, wherein an output terminal of the boost circuit further connects to a DC to DC conversion circuit.

8. The power factor correction circuit as claimed in claim 3, wherein an output terminal of the boost circuit further connects to a DC to DC conversion circuit.

9. The power factor correction circuit as claimed in claim 4, wherein an output terminal of the boost circuit further connects to a DC to DC conversion circuit.

10. The power factor correction circuit as claimed in claim 5, wherein an output terminal of the boost circuit further connects to a DC to DC conversion circuit.

11. The power factor correction circuit as claimed in claim 5, wherein the DC to DC conversion circuit is an LLC resonant converter.

12. The power factor correction circuit as claimed in claim 6, wherein the DC to DC conversion circuit is an LLC resonant converter.

13. The power factor correction circuit as claimed in claim 7, wherein the DC to DC conversion circuit is an LLC resonant converter.

14. The power factor correction circuit as claimed in claim 8, wherein the DC to DC conversion circuit is an LLC resonant converter.

15. The power factor correction circuit as claimed in claim 9, wherein the DC to DC conversion circuit is an LLC resonant converter.
